(19) United States
(12) Patent Application Publication
(10) Pub. No.: US 2007/0137409 A1
(43) Pub. Date: Jun. 21, 2007

(54) Uni mount handguard

(76) Inventors: Kenneth T. Laivins, Hebron, OH (US); Glen A. Laivins, Hebron, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 11/259,793

(22) Filed: Oct. 27, 2005

(51) Int. Cl. B62K 21/12; B62K 21/26

(52) U.S. Cl. 74/551.9; 74/551.1

(57) ABSTRACT

A handguard assembly for a handlebar is disclosed herein. In one embodiment, the handguard mounting assembly includes a central member, at least one mounting device configured to connect the central member to at least one handlebar, and at least one pair of arms configured to connect the central member to a pair of handlebars. Hand shields may be connected to the handguard mounting assembly to protect a rider's hands from wind and debris.

### FIELD OF INVENTION

The present application relates to a handguard for a handlebar. In particular, the present application relates to a uni mount handguard for a handlebar of a vehicle, such as a motorbike, motorcycle, motor scooter, bicycle, or all-terrain vehicle (“ATV”).

### BACKGROUND

Handguards for protecting the hands of riders of motorbikes, motorcycles, motor scooters, bicycles, and ATVs are known in the art. The handguard is configured to protect a rider's hands from wind, rain, and debris.

In one known embodiment, two separate handguards are configured to be mounted on a pair of handlebars. A left handguard includes a left arm member, a left shield member, and a mounting member, and is mounted to a left handlebar. A right handguard includes a right arm member, a right shield member, and a mounting member, and is mounted to a right handlebar. The left and right handguards are not directly connected.

### BRIEF DESCRIPTION OF THE DRAWINGS

In the accompanying drawings, structures are illustrated that, together with the detailed description provided below, describe exemplary embodiments of the claimed invention.

In the drawings and description that follows, like elements are identified with the same reference numerals. The drawings are not to scale and the proportion of certain elements may be exaggerated for the purpose of illustration.

FIG. 1 is a simplified perspective view of one embodiment of a handguard assembly 100 with a shield 110 disposed on a motorcycle M;

FIG. 2 is a simplified front perspective view of one embodiment of a handguard assembly 100 attached to a handlebar H;

FIG. 3 is an exploded back perspective view of one embodiment of a handguard assembly 100;

FIGS. 4A and 4B are simplified front plan views of one embodiment of a central member 120 in first and second orientations, respectively;

FIG. 4C is a simplified front plan view of another embodiment of a central member 400.

FIG. 5A is a simplified perspective view of one embodiment of a mounting device 130;

FIG. 5B is a simplified perspective view of an alternative embodiment of a mounting device 500;

FIG. 6 is a simplified perspective view of one embodiment of an arm member 140;

FIG. 7 is a simplified front perspective view of one embodiment of a handguard assembly 100 with an inverted central member 120; and

FIG. 8 is a simplified side view of one embodiment of the handguard assembly 100 in different positions relative to a handlebar H.

### DETAILED DESCRIPTION

The present application is directed to a uni mount handguard for a handlebar of a vehicle, such as a motorbike, a motorcycle, a motor scooter, a bicycle, or an ATV. The handguard may be employed to protect a rider's hand from wind, rain, and debris.

“Right” and “left” as used herein refer to the right and left directions as viewed from the perspective of a rider of the vehicle.

An “inner” direction as used herein refers to a direction towards the body of the vehicle.

An “outer” direction as used herein refers to a direction away from the body of the vehicle.

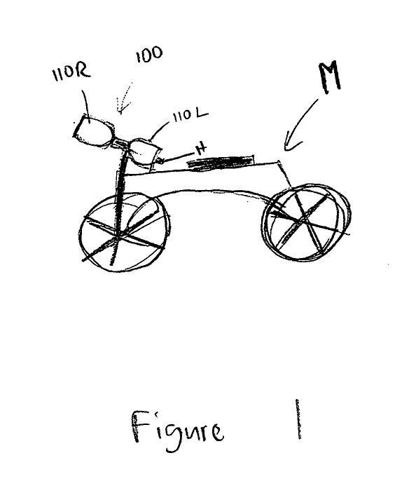

FIG. 1 illustrates a simplified perspective view of one embodiment of a handguard assembly 100, including right and left shields 110L,R, mounted on a handlebar H of a motorbike M. In this embodiment, the handguard assembly 100 is positioned in front of the handlebar H to protect a rider's hand. In alternative embodiments, the handguard assembly 100 may be employed on a motorcycle, motor scooter, bicycle, ATV, or any other vehicle having handlebars.

Each shield 110L,R may be constructed of a variety of polymeric materials, including, without limitation, polypropylene, polyethylene, ethylene propylene diene monomer (EPDM) rubber, or a combination thereof. Polypropylene provides stiffness to the shields 110L,R, while polyethylene provides resilience and EPDM rubber provides flexibility.

Since each shield 110L,R is constructed of a polymeric material, it can be molded to include complex features and to facilitate installation on a handlebar H. Furthermore, a polymeric material can flex to the shape of a handlebar H, allowing each shield 110L,R to be attached to handlebars of different shapes and sizes. Additionally, the use of a polymeric material allows each shield 110L,R to absorb impacts and retain its shape.

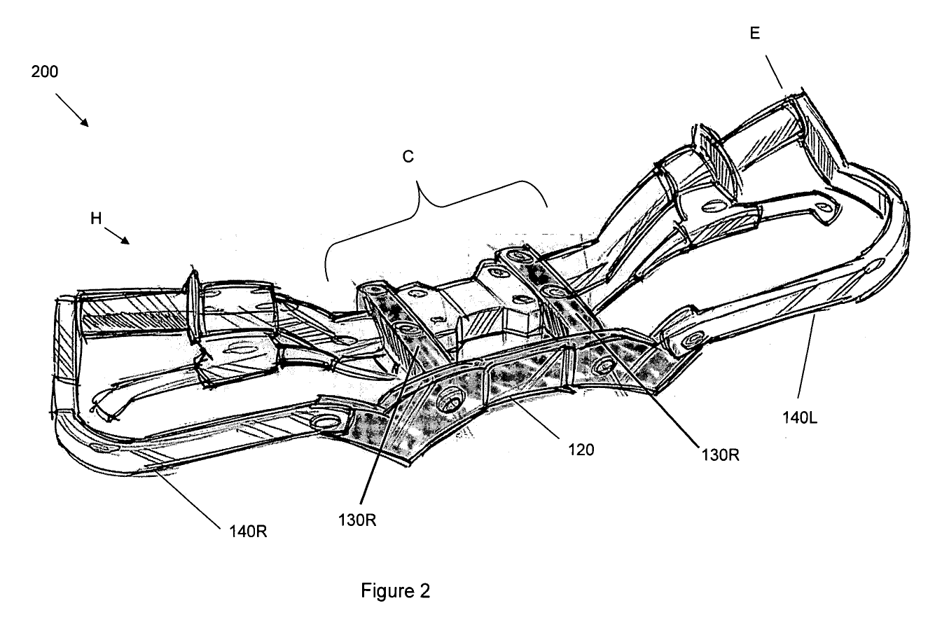

FIG. 2 illustrates a simplified front perspective view of one embodiment of a handguard assembly 100 attached to a handlebar H. In this illustrated embodiment, the shields 110L,R have been removed. The handguard assembly 100 includes a central member 120, left and right mounting devices 130L,R, and left and right arm members 140L,R. As shown in the illustrated embodiment, the central member 120 is connected to the left and right mounting devices 130L,R, which are, in turn, connected to a low bend in the central section C of the handlebars H. The central member 120 is also connected to the left and right arm members 140L,R, which are in turn connected to end portions E of the left and right handlebars H, respectively.

In an alternative embodiment (not shown), the handguard assembly 100 includes a single mounting device. In another alternative embodiment (not shown), the handguard assembly 100 includes two or more left arm members and two or more right arm members.

As will be explained in further detail below, in one embodiment, each arm member 140L,R has two apertures (not shown) while each shield 110 has two corresponding apertures (not shown), such that the shields 110 may be attached to the arm members 140L,R via fasteners (not shown). In alternative embodiments (not shown), the support member and shield each have a single aperture or the support member and shield each have three or more apertures.

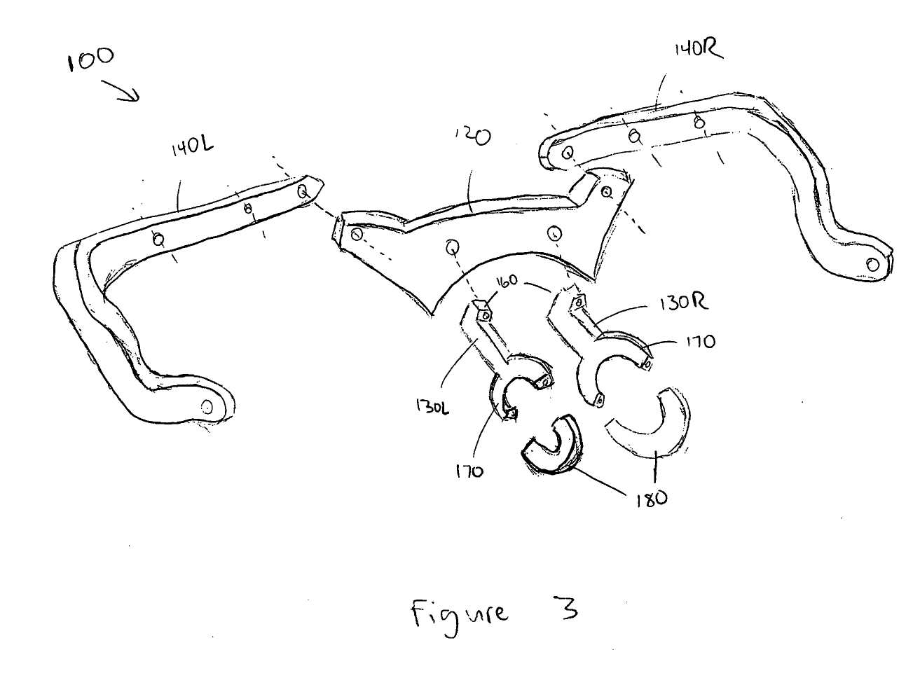

FIG. 3 illustrates an exploded back perspective view of one embodiment of a handguard assembly 100. In this embodiment, the mounting devices 130L,R are elongated members having mounting flanges 160 at a front end, and C-shaped portions 170 at a back end. The C-shaped portions 170 are configured to be attached to C-shaped brackets 180.

In FIG. 3, the C-shaped portions 170 of each mounting device 130L,R are disposed in an upright configuration. In an alternative embodiment illustrated (not shown), the C-shaped portion of a mounting device is disposed horizontally. In other alternative embodiments (not shown), the C-shaped portion of a mounting device may be disposed in any orientation.

In one embodiment, the mounting devices 130L,R are constructed of metal and can be manufactured by CNC manufacturing, stamping, and forging. In another embodiment, the mounting devices 130L,R are constructed of a polymeric material. The polymeric material of the mounting devices 130L,R may be different from the polymeric material of the shield 110, to provide for different levels of strength.

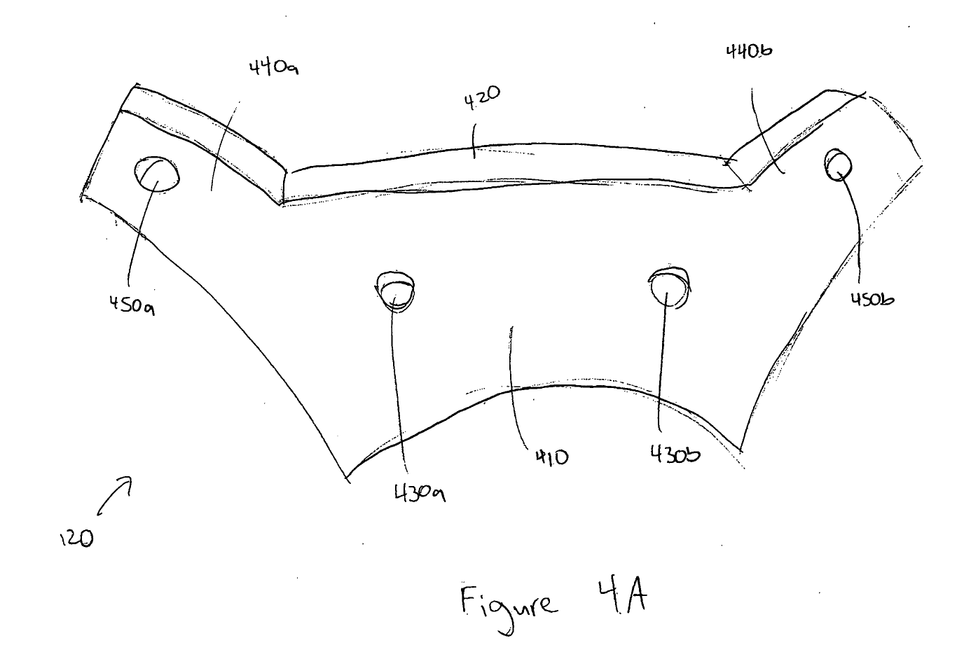

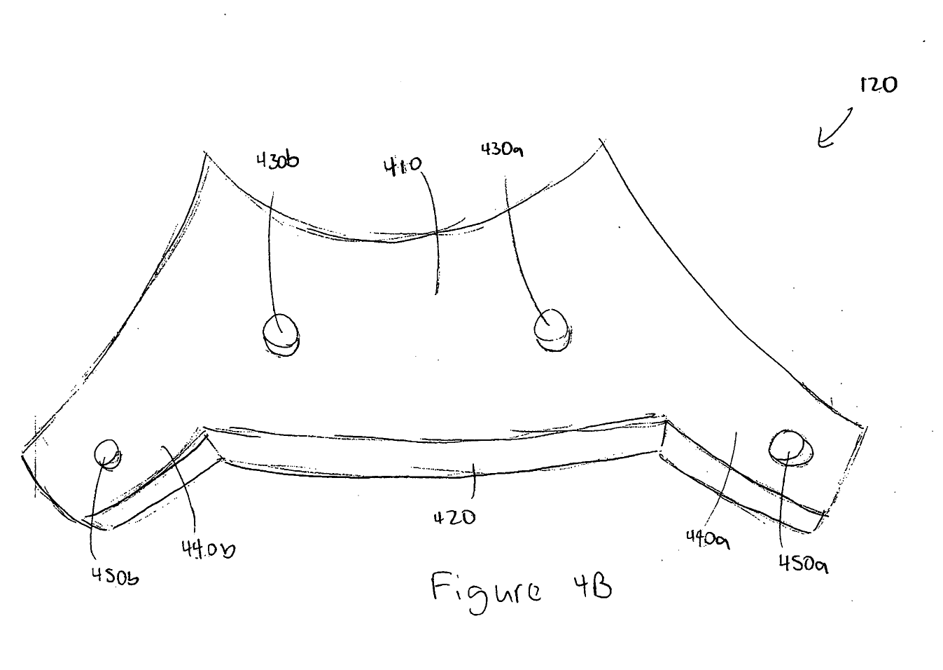

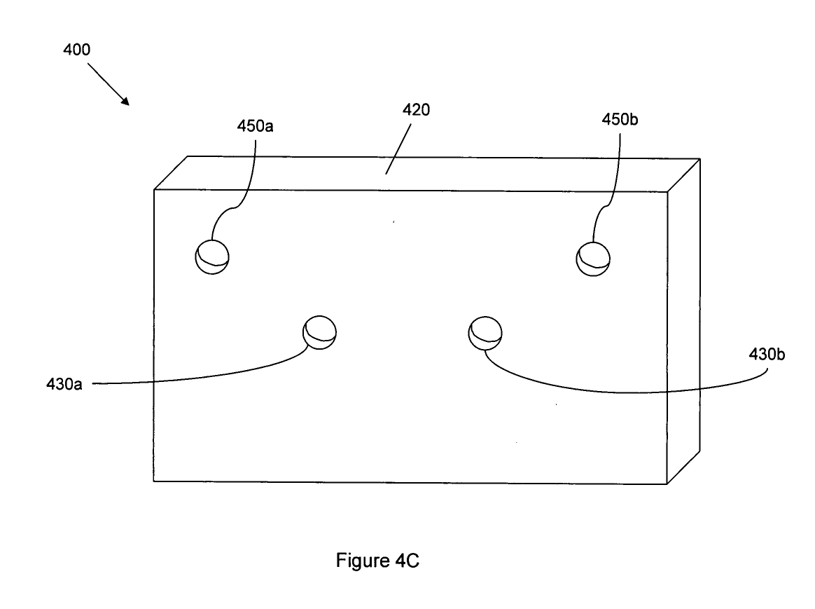

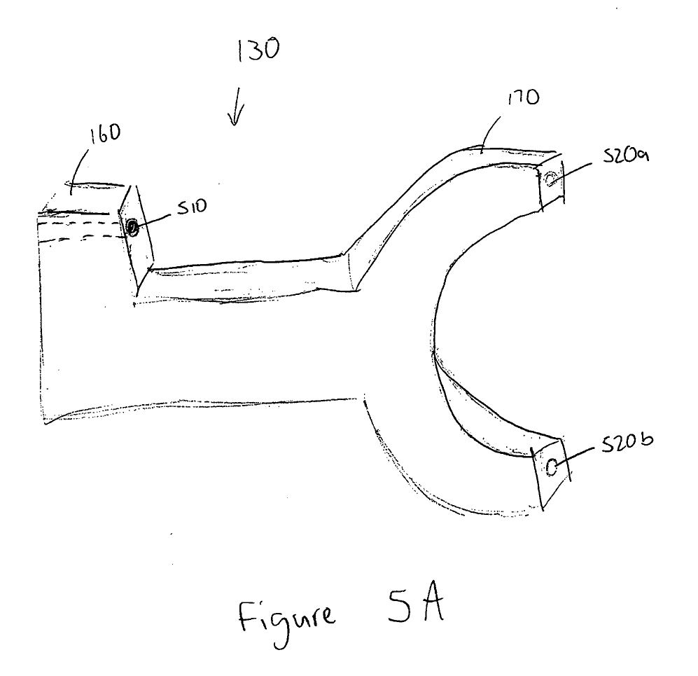

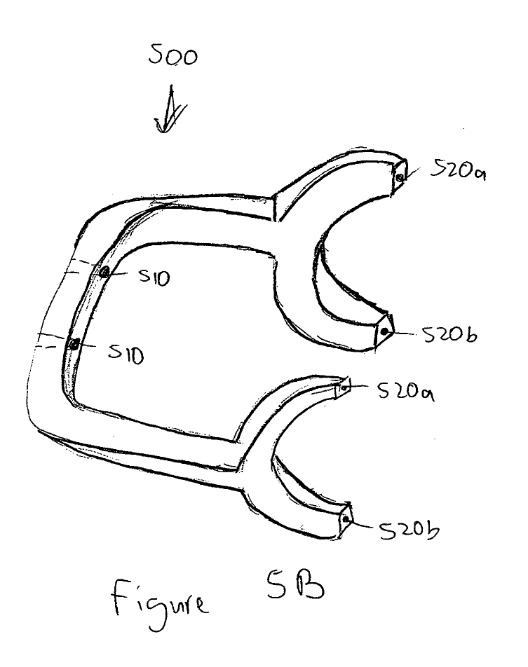

FIG. 4A illustrates a first orientation of an exemplary embodiment of a central member 120. In the illustrated embodiment, the central member 120 includes a body portion 410 having an edge 420. In the first orientation shown in FIG. 4A, the edge 420 is at the top of the body portion 410. In a second orientation, shown in FIG. 4B, the central member 120 is inverted by 180°, such that the edge 420 is at the bottom of the body portion 410. The body portion 410 further includes a pair of apertures 430a,b configured to receive fasteners (not shown). Exemplary fasteners include, without limitation, screws, bolts, ties, or any other appropriate fastening devices. As will be explained further below, in reference to FIG. 5A, the apertures 430a,b correspond with apertures in the mounting flanges 160 of the mounting devices 130L,R.

With continued reference to FIG. 4A, the central member 120 further includes a pair of wing portions 440a,b. Each wing portion 440a,b is located at an end of the body portion 410. Each wing portion has an aperture 450a,b configured to receive fasteners (not shown). Exemplary fasteners include, without limitation, screws, bolts, ties, or any other appropriate fastening devices.

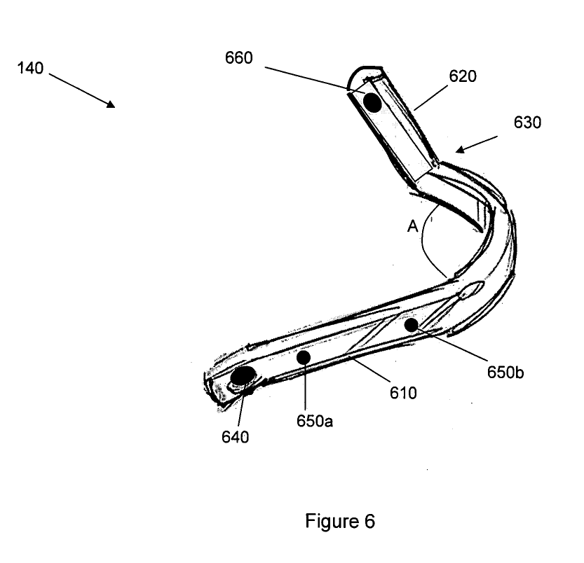

In the first orientation, illustrated in FIG. 4A, the wing portions 430a,b extend above the edge 420 such that the apertures 450a,b are located above the edge 420. In the second orientation, illustrated in FIG. 4B, the wing portions 430a,b extend below the edge 420 such that the apertures 450a,b are located below the edge 420. As will be explained further below, in reference to FIG. 6, the apertures 450a,b correspond with apertures in the arm members 140L,R.

In an alternative embodiment (not shown), the central member includes an aperture configured to accommodate at least one cable, such as a brake line or a control cable.

FIG. 4C illustrates an alternate embodiment of a central member 400. In this embodiment, the central member 400 is a rectangular member having a first pair of apertures 430a,b and a second pair of apertures 450a,b. In the illustrated orientation, the second pair of apertures 450a,b are located above the first pair of apertures 430a,b. In a second orientation, in which the central member 400 is inverted, the second pair of apertures 450a,b are located below the first pair of apertures 430a,b. In other alternative embodiments (not shown), the central member may be of any shape.

In one embodiment, the central member 120 is constructed of metal and can be manufactured by CNC manufacturing, stamping, and forging. In another embodiment, the central member 120 is constructed of a polymeric material. The polymeric material of the central member 120 may be different from the polymeric material of the shield 110, to provide for different levels of strength.

FIG. 5A illustrates a simplified side view of a mounting device 130. The mounting flange 160 of each mounting device 130 includes an aperture 510 corresponding to one of the apertures 430a,b in the body portion 410 of the central member 120. With reference to FIGS. 3, 4A, and 5A, a fastener (not shown) is passed through the apertures 430a,b of the body portion 410 of the central member 120 and each corresponding aperture 160 of the mounting flange 160 of each mounting device 130L,R, thereby fixing the central member 120 to the mounting devices 130L,R.

In alternative embodiments (not shown), the central member 120 and/or the mounting devices 130L,R may include substantially horizontal or substantially vertical slots instead of apertures. Slots would allow the position of the mounting devices 130L,R to be adjustable relative to the central member 120 so that the handguard assembly 100 can accommodate handlebars or various sizes and configurations. For example, a central member having substantially vertical slots would allow a rider to adjust the mounting devices to accommodate handlebars having triple mount clamps. In one embodiment, the central member has substantially horizontal slots and the mounting devices have substantially vertical slots, thus allowing a rider to adjust the mounting devices in a substantially horizontal direction relative to the handlebars, and to further adjust the central spar in a substantially vertical direction relative to the handlebars. In other embodiments (not shown) the mounting flange 160 of each mounting device 130 includes two or more apertures (not shown).

With continued reference to FIG. 5A, the C-shaped portion 170 of each mounting device 130 has a pair of apertures 520a,b configured to receive fasteners (not shown) to connect each mounting device 130 to a C-shaped bracket 180 (as shown in FIG. 3). Exemplary fasteners include, without limitation, screws, bolts, ties, or any other appropriate fastening devices. The C-shaped bracket 180 and the C-shaped portion 170 of each mounting device 130 are joined by fasteners to create a friction fit around a handlebar H. In another embodiment (not shown) the C-shaped portion 170 of each mounting device 130 includes three or more apertures (not shown). In yet another embodiment (not shown), the mounting device is a unitary mounting bracket. For example, the back end of each mounting device 130 may be an adjustable clamp that connects to the handlebar H. In an additional alternative embodiment (not shown), the left and right mounting devices may be replaced with a U-shaped mounting device.

In an alternative embodiment (not shown), each mounting device includes an aperture configured to accommodate at least one cable, such as a brake line or a control cable.

FIG. 5B illustrates an alternative embodiment of a single mounting device 500 that could be used in place of left and right mounting devices 130L,R. In this embodiment, the mounting device 500 is substantially U-shaped. The base of the “U” includes a pair of apertures 510 that correspond to the apertures 450a,b of the body portion of the central member 120. The remaining components of the single mounting device 500 is substantially the same as the left and right mounting devices 130L,R.

In one embodiment, the mounting devices 130L,R are constructed of metal and can be manufactured by CNC manufacturing, stamping, and forging. In another embodiment, the mounting devices 130L,R are constructed of a polymeric material. The polymeric material of the mounting devices 130L,R may be different from the polymeric material of the shield 110, to provide for different levels of strength.

FIG. 6 illustrates a simplified perspective view of an exemplary left arm member 140L. It should be understood that an exemplary right arm member has substantially the same, but complementary components. As shown in the illustrated embodiment, the arm member 140 is generally L-shaped, such that when the handguard assembly 100 is connected to a vehicle, a major segment 610 of the arm member 140 extends in front of the handlebars H and a minor segment 620 of the arm member 140 is substantially orthogonal to the handlebars H. The major segment 610 is oriented at an angle A with respect to the minor segment 620, wherein angle A is chosen such that the major segment 610 is at an optimal distance from the handlebar H. The major segment 610 should be close enough to the handlebar H to maximize protection of a rider's hands, yet far enough away from the handlebar H to allow a rider to quickly remove his hands if necessary. In one embodiment, angle A is between 70-75°. In the illustrated embodiment, angle A is approximately 71°. In an alternative embodiment (not shown), the major segment 610 is substantially perpendicular to the minor segment 620.

With continued reference to FIG. 6, the minor segment 620 of the arm member 140 includes a V-shaped bend 630, as shown. In other words, if a top view of the arm member 140 is taken to be an X-Y plane, the arm portion is bent downwards in a Z direction. In this configuration, at least a portion of the minor segment 620 extends below the handlebar H, allowing a rider to quickly remove his hand from the handlebar H if necessary. In an alternative embodiment (not shown), the minor segment of the arm member is straight.

In the illustrated embodiment, the major segment 610 includes a primary aperture 630 that corresponds to one of the apertures 450a,b of the wing portions 440a,b of the central member 120. With reference to FIGS. 3, 5A, and 6, a fastener (not shown) is passed through the apertures 450a,b of the wing portions 440a,b of the central member 120 and each corresponding primary aperture 630 of the major segment 610 of each arm member 140L,R, thereby fixing the central member 120 to the arm members 140L,R.

The major segment further includes a pair of secondary apertures 640a,b that correspond to a pair of apertures (not shown) on the shield member 110. A fastener (not shown) is passed through the apertures of the shield member 110 and the corresponding secondary apertures 640a,b of the major segment 610 of each arm member 140L,R, thereby fixing the shield members 110 to the arm members 140L,R.

With continued reference to FIG. 6, the minor segment 620 includes an aperture 650 configured to receive a fastener (not shown) to attach the minor segment 620 to a handlebar H. Exemplary fasteners include, without limitation, screws, bolts, ties, or any other appropriate fastening devices.

In one embodiment, the arm members 140L,R are constructed of metal and can be manufactured by CNC manufacturing, stamping, and forging. In an alternative embodiment, the arm members 140L,R are constructed of a polymeric material. The polymeric material of the arm members 140L,R may be different from the polymeric material of the shield 110, to provide for different levels of strength. In another alternative embodiment (not shown), the major segment of the arm members may be configured as shield portions, thus eliminating the need for separate shields.

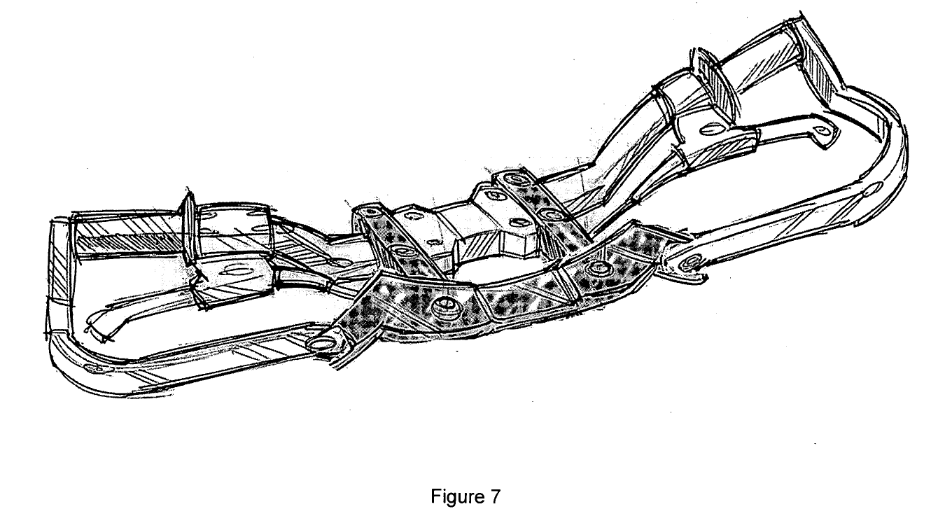

FIG. 7 illustrates a simplified front perspective view of one embodiment of a handguard assembly 100 with an inverted central member 120. In this illustrated embodiment, the handguard assembly 100 is assembled as described above, with reference to FIGS. 3, 4A, 5A, and 6, except that the central member 120 is placed in the second orientation, as shown in FIG. 4B. When the handguard assembly is assembled in this fashion, the left and right arm members 140L,R are connected to the central member 120 at a lower position, and thus the left and right shields 110L,R are also in a lower position. In this manner, a rider may attach the handguard assembly 100 to handlebars H of a vehicle at a position of his preference.

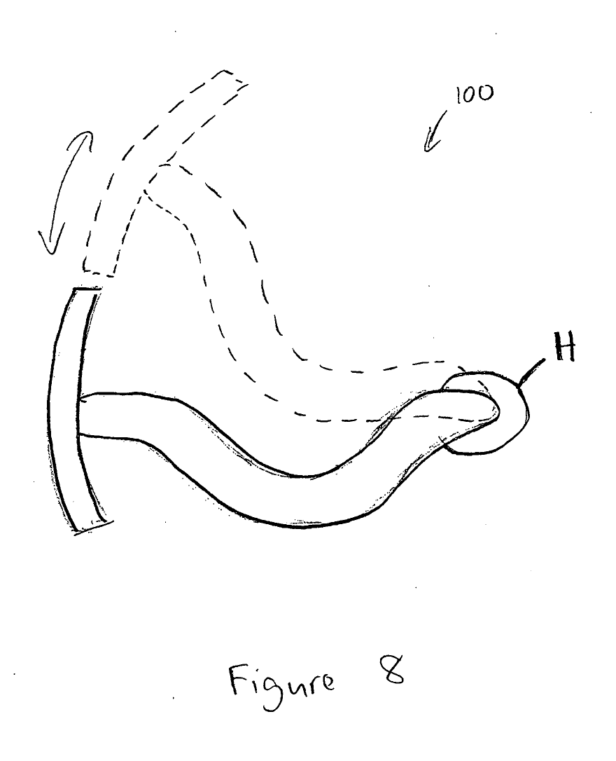

FIG. 8 illustrates a side plan view of a handguard assembly 100 connected to a handlebar H according to another embodiment of the present application. In this embodiment, after the handguard assembly 100 has been mounted to the handlebars H of a vehicle, the rider may pivotally adjust the handguard assembly 100 about the handlebars H to a preferred position. The fastener (not shown) that passes through the aperture 650 of the minor segment 620 of each arm member 140 forms a friction fit inside a cavity (not shown) of the handlebar H, such that the fastener may be pivoted if appropriate pressure is applied to the handguard assembly 100. Likewise, the mounting devices 130L,R form a friction fit with the lower bend of the handlebars H, such that the mounting devices 130L,R may be pivoted if appropriate pressure is applied to the handguard assembly 100.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus, and illustrative examples shown and described. Accordingly, departures may be made from such details without departing from the spirit or scope of the applicant's general inventive concept.

1. A handguard assembly for a pair of handlebars, the handguard mounting assembly comprising:
a central member;
at least one mounting device configured to connect to the central member and to an inner portion of at least one of the handlebars; and
at least one pair of arms configured to connect to the central member, each arm being further configured to connect to an end portion of a respective handlebar.

2. The handguard assembly of claim 1, further comprising a pair of shields, each shield configured to connect to a respective arm.

3. The handguard assembly of claim 1, wherein the central member is adjustable in at least a substantially vertical direction relative to the pair of handlebars.

4. The handguard assembly of claim 1, wherein the central member is configured to be attached to the at least one mounting device in more than one orientation.

5. The handguard assembly of claim 4, wherein the central member is configured to be attached to the at least one mounting device in a first orientation and is further configured to be rotated 180° to be attached to the mounting device in a second orientation.

6. The handguard assembly of claim 1, wherein the at least one mounting device includes at least first and second mounting devices.

7. The handguard assembly of claim 6, wherein the first and second mounting devices are configured to be adjusted in at least a substantially horizontal direction relative to the pair of handlebars.

8. The handguard assembly of claim 1, wherein the handguard mounting assembly is pivotally adjustable with respect to the handlebars.

9. The handguard assembly of claim 1, wherein the handguard mounting assembly includes at least one aperture configured to accommodate at least one cable.

10. A handguard kit for a handguard configured to be attached to a pair of handlebars of a vehicle, the handguard kit comprising:
a central member;
at least one pair of arm members, each arm member being configured to connect to the central member and to an end portion of a respective handlebar; and
at least one mounting member configured to connect to the central member and to an inner portion of a handlebar.

11. The handguard kit of claim 10, wherein the arm members are generally L-shaped, each arm member having a minor segment configured to extend substantially perpendicularly from an end of the handlebar in a forward direction and a major segment configured to extend in front of the handlebar.

12. The handguard kit of claim 10, wherein the minor segment of each arm member has a V-shaped bend.

13. The handguard kit of claim 10, wherein the central member includes a body portion having an edge, and a pair of wing portions extending from opposite ends of the body portion such that the wing portions extend past the edge of the body portion.

14. The handguard kit of claim 13, wherein the central member is configured to be connected to the arm members and the at least one mounting member in at least two orientations, including at least a first orientation, wherein the edge is positioned at the top of the body portion, and a second orientation, wherein the edge is positioned at the bottom of the body portion.

15. The handguard kit of claim 10, wherein the at least one mounting member includes at least two mounting members.

16. The handguard kit of claim 10, wherein the central member, the at least one pair of arm members, and the at least one mounting member are constructed of metal.

17. The handguard kit of claim 10, further comprising at least a pair of shield members.

18. An adjustable handguard assembly configured to accommodate handlebars of various configurations, the adjustable handguard assembly comprising:
a central member configured to be attached to the handguard assembly in at least two orientations;
a pair of mounting members configured to be connected to be connected to the central member; and
at least a pair of arms configured to be connected to the central member.

19. The adjustable handguard assembly of claim 18, further comprising a pair of shield members configured to be mounted on the arms.

20. The adjustable handguard assembly of claim 18, wherein the pair of mounting members are configured to be adjusted in at least a substantially horizontal direction relative to the central spar.
